(19) United States
(12) Patent Application Publication
(10) Pub. No.: US 2010/0243285 A1
(43) Pub. Date: Sep. 30, 2010

(54) TORQUE ADJUSTING STRUCTURE FOR AIR TOOLS

(76) Inventor: Chih-Ching HSIEH, Fongyuan City (TW)

Correspondence Address: Wang Law Firm, Inc., 4989 Peachtree Parkway,, Suite 200, Norcross, GA, 30092, US

(21) Appl. No.: 12/413,537

(22) Filed: Mar. 28, 2009

(51) Int. Cl. B23Q 5/00; B25B 23/14

(52) U.S. Cl. 173/176; 81/467

(57) ABSTRACT

A torque adjusting structure for an air tool includes an accommodating device and a torque device. The accommodating device has a head part and a body part. The head part is formed with a hollow groove. The bottom of the groove is provided with abase on which a connecting element is provided for the nozzle of the air tool to connect. The base is formed with an air inlet connecting the connecting element and the external space. The torque device has an acting part and an adjusting part. The torque device connects to the body part of the accommodating device rising one end of its acting part. The other end of the acting part connects to the adjusting part.

### BACKGROUND OF THE INVENTION

1. Field of Invention

The invention relates to a torque adjusting structure and, in particular, to a torque adjusting structure for air tools.

2. Related Art

Air tools are common tools used by car maintenance mechanics and machine manufacturers. They are often used to fasten or loosen objects. A highly pressurized air is sued to output a large torque. However, there is no torque adjusting device in conventional air tools. Therefore, if the assembly requires precision torque controls, such as engine cases, cylinders, and clutches, it has to be done manually using a torque wrench. This inevitably increases the operation time and lowers the work efficiency. It is thus imperative to provide a solution.

### SUMMARY OF THE INVENTION

An objective of the invention is to provide a torque adjusting structure for an air tool that enables its user to adjust the torque while using the air tool.

To achieve the above-mentioned objective, the disclosed torque adjusting structure for power tools includes an accommodating device and a torque device.

The accommodating device has a head part and a body part. The head part is formed with a hollow groove. The bottom of the groove is provided with a base on which a connecting element is provided for the nozzle of the air tool to connect. The base is formed with an air inlet connecting the connecting element and the external space.

The torque device has an acting part and an adjusting part. The torque device connects to the body part of the accommodating device using one end of its acting part. The other end of the acting part connects to the adjusting part.

### BRIEF DESCRIPTION OF THE DRAWINGS

The invention will become more fully understood from the detailed description given herein below illustration only, and thus is not limitative of the present invention, and wherein:

FIG. 1 is a schematic three-dimensional view of the invention;

FIG. 2 is a schematic view of the invention in use, showing the state when the air tool is mounted onto the invention:

FIG. 3 is a cross-sectional view of the invention in use;

FIG. 4 is a schematic view of the invention in use, showing the state of dismounting the air tool from the invention.

### DETAILED DESCRIPTION OF THE INVENTION

The present invention will be apparent from the following detailed description, which proceeds with reference to the accompanying drawings, wherein the same references relate to the same elements.

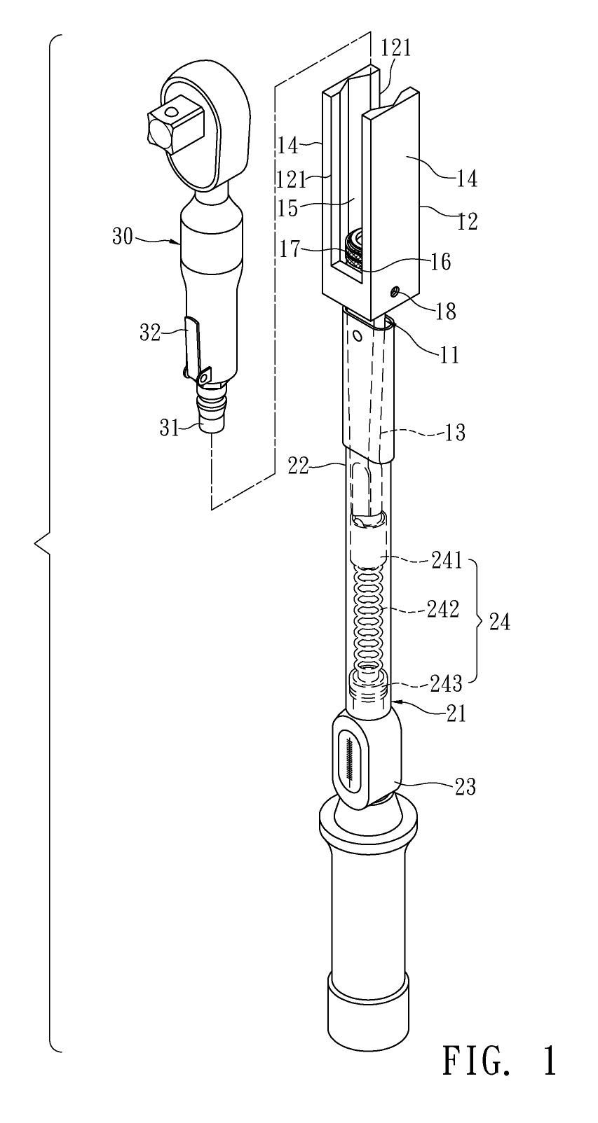

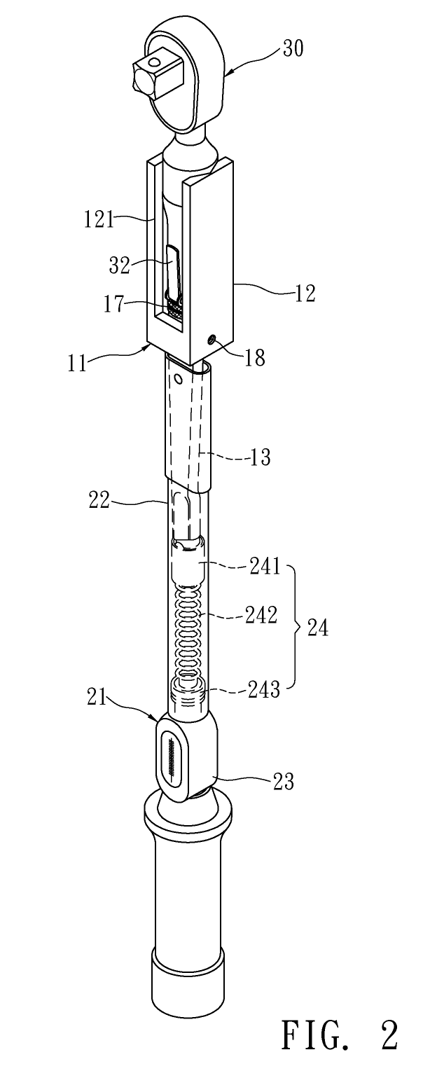

Please refer to FIGS. 1 and 2. The torque adjusting structure for air tools according to the invention includes an accommodating device 11 and a torque device 21.

In particular, the accommodating device 11 has a head part 12 and a long handle-shaped body part 13. At least one side of the head part 12 of the accommodating device 11 has an opening 121. A hollow groove 15 is formed in the head part 12 in connection with the opening 121. In this embodiment, the two opposite sides of the head part 12 are extended upwards respectively with a sidewall 14, thereby forming two opposite openings 121. The hollow groove 15 is formed between the two sidewalls 14 of the head part 12. The bottom of the groove 15 of the head part 12 is formed with a base 16, which has a connecting element 17 for the connection of a nozzle 31 of the air tool 30. In this embodiment, the connecting element 17 is a quick-release connector. Since such a connector is well-known in the prior art, its detailed structure and functioning principles are not further described here. An air inlet 18 is formed inside the base 16 to connect the connecting element 17 and the external space.

The torque device 21 has an acting part 22 and an adjusting part 23. The acting part is a hollow tube with a supporting assembly installed therein. The supporting assembly 24 consists of a top part 241, an elastic element 242, and a fixing base 243. The upper end of the top part 241 engages with the body part 13 of the accommodating device. The lower end of the top part 241 connects to one end of the elastic element 242. The other end of the elastic element 242 connects to the fixing base 243. Then the fixing base 243 connects to the adjusting part 23. The adjusting part 23 allows the user to adjust the torque value according to needs. The elastic element 242 of the supporting assembly 24 is urged so that it fasten or loosen itself according to the adjusted torque value.

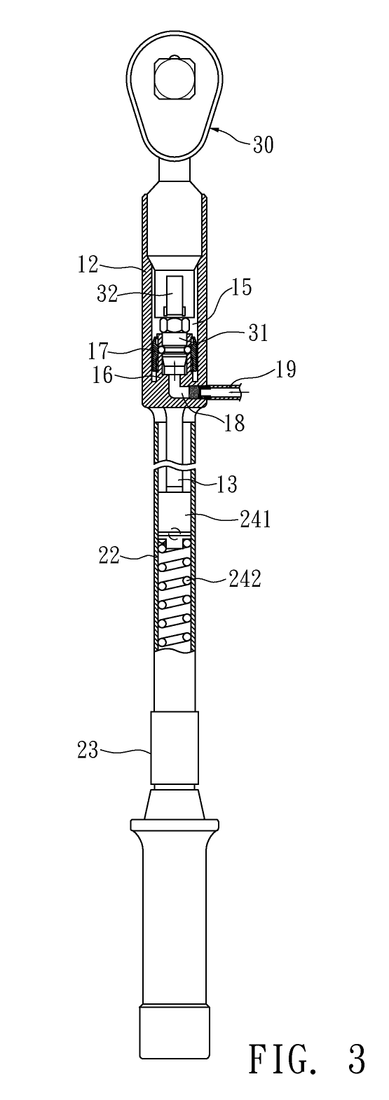

With reference to FIG. 3, when the invention is in use, the air inlet 18 on the head part 12 of the accommodating device 11 is first external connected with an air pipeline that supplies high-pressure air. The highly pressurized air is transported via the air inlet 18 into the connecting element 17 of the base 16. When the user mounts an air tool 30 with a switch 32 onto the groove 15 of the accommodating device 11 and connects the nozzle 31 of the air tool 30 with the connecting element 17 on the base 16, the air tool 30 is driven by the high-pressure air entered via the air inlet 18. As the user operates the air tool 30 to fasten or loosen a nut or bolt and the strength reaches a torque value predetermined by the user, the lower end of the body part 13 on the accommodating device 11 escapes from the top part 241 of the supporting assembly 24 as the engaging force provided by the elastic element 242 in the supporting assembly 24 is insufficient. In this case, the air tool 30 can no longer fasten or loosen the nut or bolt. This prevents the air tool from over-fastening or -loosening the nut or bolt. Moreover, the user can adjust the torque while using the air tool 30.

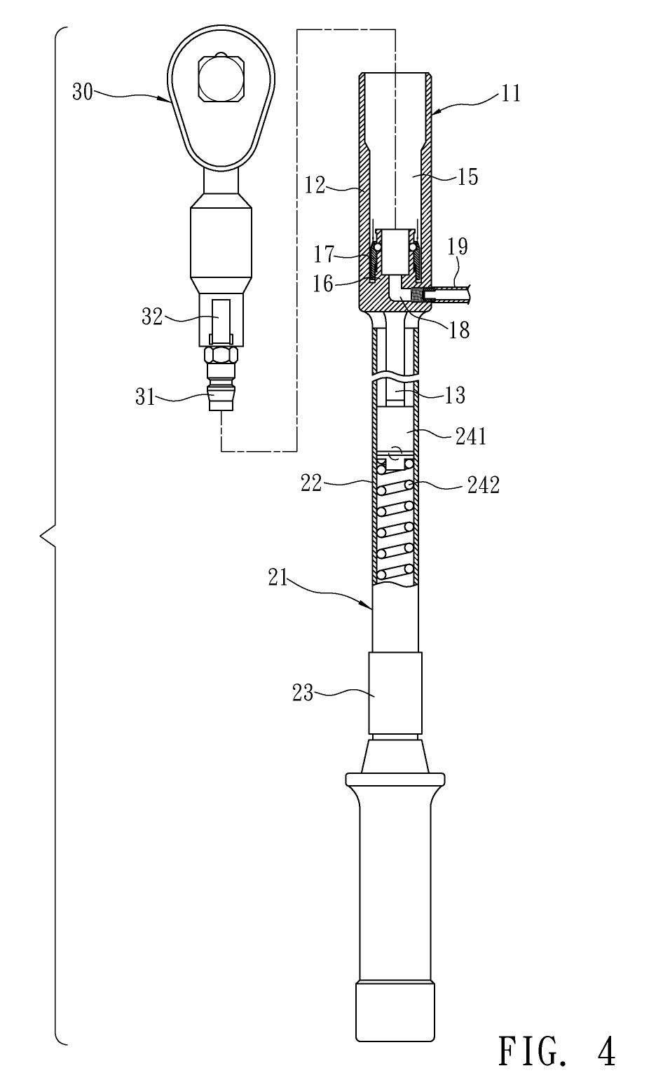

However, it should be particularly emphasized that the invention uses a quick-release connector as the connecting element 17 to connect with the nozzle 31 of the air tool 30. Therefore, when dismounting the air tool 30, as shown in FIG. 4, the user simply presses the connecting element 17 on the base 16. Such an action releases the engaging state between the connecting element 17 and the nozzle 31 of the air tool 30. The air tool 30 is thus quickly departed from the accommodating device 11. Using such a structure, the air tool 30 can be readily mounted on or dismounted from the accommodating device 11 of the invention.

In summary, the disclosed torque adjusting structure for air tools enables its user to adjust the torque value while using the air tool. The mounting and dismounting of the air tool is simple and quick. Therefore, the invention has made a significant progress from the prior art.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A torque adjusting structure for an air tool, comprising an accommodating device and a torque device; wherein
the accommodating device has a head part and a body part, the head part is formed with a hollow groove whose bottom has a base, the base is provided with a connecting element for a nozzle of the air tool to connect, and the base is formed with an air inlet that connects the connecting element and the external space; and
the torque device has an acting part and an adjusting part, one end of the acting part being connected with the body part of the accommodating device and the other end thereof being connected with the adjusting part.

2. The torque adjusting structure for an air tool of claim 1, wherein at least one side of the head part of the accommodating device has an opening in communication with the hollow groove.

3. The torque adjusting structure for an air tool of claim 1, wherein the two opposite sides of the head part of the accommodating device are extended upwards respectively with a sidewall to form two opposite openings and the hollow groove is formed between the two sidewalls.

4. The torque adjusting structure for an air tool of claim 1, wherein the acting part is a hollow tube with a supporting assembly mounted therein, the supporting assembly consists of a top part, an elastic element, and a fixing base, the upper end of the top part connects to the body part of the accommodating device and the lower part thereof connects to one end of the elastic element, the other end of the elastic element connects to the fixing base, and the fixing base connects to the adjusting part, the adjusting part enables its user to adjust the torque value to urge the elastic element of the supporting assembly, and the elastic element fastens or loosen itself according to the adjusted torque value.

5. The torque adjusting structure for an air tool of claim 1, wherein the air inlet on the head part of the accommodating device is externally connected with an air pipeline that supplies high-pressure air, pumping the high-pressure air through the air inlet and to the connecting element on the base.

6. The torque adjusting structure for an air tool of claim 1, wherein the connecting element is a quick-release connector.
